(19) United States
(12) Patent Application Publication
(10) Pub. No.: US 2018/0050793 A1
(43) Pub. Date: Feb. 22, 2018

(54) DEVICE FOR ASSISTING WITH THE RECOVERY PHASE OF A FIXED-WING AIRCRAFT

(71) Applicant: DELAIR-TECH, LABEGE (FR)

(72) Inventors: MICHAEL DE LAGARDE, TOULOUSE (FR); BENJAMIN MICHEL, TOULOUSE (FR); ALEXANDRE LAPADU, COLOMIERS (FR); QUENTIN DELPLANQUE, TOULOUSE (FR); PIERRE GILLES, TOULOUSE (FR); MAXIME PITON, TOULOUSE (FR); CHRISTOPHE CHANUDET, TOULOUSE (FR)

(21) Appl. No.: 15/544,249

(22) PCT Filed: Jan. 25, 2016
(86) PCT No.: PCT/FR2016/050144

§ 371 Date: Jul. 17, 2017

(30) Foreign Application Priority Data
Jan. 23, 2015 (FR) 1550540

(51) Int. Cl. B64C 25/58; B64C 39/02; B64C 5/02; B64C 9/32

(52) U.S. Cl. CPC B64C 25/58; B64C 39/024; B64D 25/00; B64C 9/32; B64C 5/02

(57) ABSTRACT

A fixed-wing aircraft includes at least one passive landing assistance unit configured to be deployed in a first position used in normal flight and a second position used for emergencies. A trigger to activate the transition from the first position to the second position. The aircraft also includes landing gear made of memory foam.

### TECHNICAL FIELD OF THE INVENTION

The present invention relates to an aircraft. It relates more particularly to fixed-wing aircraft of drone type.

### STATE OF THE ART

Drones are generally used to monitor particular areas of interest on the ground, without requiring the presence of human pilots. Drones are used in particular to regularly, practically continuously, overfly sensitive areas. They are in this case provided with image acquisition means and means for remotely transmitting these images to a control station. In such applications, the drones preferentially have to have great flight autonomy, of the order of several hours. They also have to be capable of automatically managing certain flight situations, notably in cases of emergency.

Many types of drones are already known, the sizes of which vary from a few tens of centimeters to several meters of wingspan.

These aircraft are generally controlled remotely, for example by radio control, or are auto-piloted during at least a part of their mission. They then comprise means for computing and controlling their control surfaces, according to a previously coded logic.

For all the aircraft and more particularly the drones, the landing phase, particularly in cases of emergency, is one of the most critical, because of the danger presented during this phase both for the craft and for the goods or people on the ground. One of the problems with drones is being able to return to the ground in any situation safely.

Because of these constraints of autonomy, of control of movement during the flight and the landing, and of safety, the drones are made complex to design, and are as yet little used, except for military needs.

The correct control of the craft during all the flight phases is therefore essential to the operational implementation of drones and to the expansion of their use.

### OBJECT OF THE INVENTION

The present invention aims to remedy all or some of these drawbacks.

To this end, according to a first aspect, the present invention targets a fixed-wing aircraft, comprising at least one passive landing assistance means, that can be deployed between a first position, used in normal flight, and a second position, and a means for triggering the transition from the first position to the second position, said aircraft further comprising a landing gear made of foam with shape memory (17).

In a particular embodiment, said means for triggering the transition from the first position to the second position, used in case of emergency, is activated automatically in case of loss of control of the aircraft, possibly by a remote controller.

In a particular embodiment, the aircraft comprises a tail unit having a first position, called flight position, intended for normal flight, in which the airfoils forming said tail unit are positioned substantially in the axis of the flight trajectory of the aircraft, and a second position, called air braking position, intended to be implemented upon a loss of control of the aircraft, in which the tail unit performs a rotation about a pivoting axis at right angles to the longitudinal axis of said aircraft.

In a more particular embodiment, the invention targets a fixed-wing aircraft characterized in that it comprises, at the rear of its fuselage, a tail unit comprising at least two airfoils, said tail unit having, relative to the fuselage, a first position of normal flight in which the airfoils are positioned substantially in the axis X of the flight trajectory of the aircraft and a second position in which the airfoils form an angle greater than 60° with the axis X of the flight trajectory, the tail unit then forming an air brake.

By virtue of these provisions, in its air braking position, the tail unit slows down the dropping of the craft, making it possible to ensure a controlled dropping speed (for example of −8 m/s maximum) even in case of loss of control of the piloting system.

In a particular embodiment, the tail unit is a “V” type tail unit consisting of two air foils, said tail unit being secured to said fuselage by a pivot placed at right angles to the longitudinal axis X, in the plane of the main wing, said pivot being arranged substantially at mid-length under the tail unit, the aircraft also comprising a means for locking the tail unit in its flight position.

It will be understood that the position of the pivot relative to the rear tail unit determines the position of equilibrium taken by said tail unit under the effect of the aerodynamic forces. The aim here is that this position to be that for which the tail unit presents the greatest possible surface area to the relative wind.

In a particular embodiment, the aircraft is piloted by a flight control means, and the means for locking the tail unit is controlled by said flight control means.

In a more particular embodiment, the locking means comprises a breakable resistive wire and means for heating this breakable wire.

In a particular embodiment, the aircraft is piloted by control means formed here by a microcontroller linked to an electronic circuit, and the tail unit is held in the flight position by a mechanical locking means linked to the electronic circuit of said aircraft, the aircraft comprising means such that, when the electronic system of the aircraft is out of service, the tail unit switches from the flight position to the air braking position.

The locking means uses, for example, a wire, broken by the electromechanical means, the absence of electrical power supply for the electronic circuit then releasing the tail unit.

In a particular embodiment, the tail unit, once switched from the flight position to the air braking position, is held by a second mechanical locking means in this air braking position.

In this way, once the tail unit is in the air braking position, it is kept fixed while the aircraft performs its descent to the ground.

In a more particular embodiment, the tail unit is held in the air braking position by a non-return ratchet.

According to a second aspect, the present invention targets an aircraft comprising an inflatable pneumatic landing gear. In this way, the aircraft has a landing gear that can be retracted into the fuselage, that is less complex and less fragile than a wheel landing gear.

In a particular embodiment, the inflatable pneumatic landing gear has a flight position in which it is kept at vacuum pressure and is retracted into the fuselage of the aircraft and a landing position in which it is re-inflated to ambient pressure and is deployed out of the fuselage of the aircraft.

By virtue of this provision, the deployment of the landing gear is done automatically.

In a particular embodiment, the inflatable pneumatic landing gear comprises a closed chamber of the type with shape memory. By virtue of these provisions, the landing gear lines a precise shape suited to the landing of the aircraft.

In a particular embodiment, the closed chamber is kept folded back by the creation of a vacuum pressure within it, and is deployed to its natural shape by the opening of an opening valve of the chamber to the outside air.

Thus, the chamber is kept folded back by the creation of a vacuum pressure within it, and deployed by the simple opening of a valve allowing the outside air to enter into said chamber. In this way, the device avoids the hazards associated with the use in an aircraft of a compressed gas cartridge or of a pyrotechnic gas generator, and makes it possible to install a cushion of airbag type on a drone.

In a particular embodiment, the part of the landing gear intended to enter into contact with the ground bears a cover which, in flight position, forms an aerodynamic continuity with the fuselage of the aircraft.

By virtue of these provisions, the pneumatic landing gear, which is inflatable and can be retracted into the fuselage, bears a cover forming a wear skid which avoids damaging the pneumatic landing gear when it enters into contact with the ground.

In embodiments, the aircraft comprises an electronic control circuit and the inflation of the landing gear is controlled by a valve controlled by said electronic control circuit.

By virtue of these provisions, the triggering of the landing gear can be controlled at any time by a program, or triggered remotely.

In one embodiment, the aircraft comprises a wing-fuselage link that can be dislocated by virtue of a main attachment intended to absorb the forces during a normal flight (force essentially oriented along an axis orthogonal to the plane of the wings) and a fuse intended to break for “abnormal” loads encountered typically in a hard landing. Such is the case, for example, upon an abrupt stopping of the fuselage resulting in a symmetrical and forward shearing of the wing relative to the fuselage, or touchdown of one wing first, leading to an asymmetrical shearing of the wing relative to the fuselage.

In one embodiment, the aircraft comprises a fuselage-tail link that can be dislocated in case of impact or in case of release of a fail-safe hook.

In a more particular embodiment, in this case, the aircraft comprises a parachute housed in its dislocatable tail, this parachute being released upon dislocation of the tail.

### BRIEF DESCRIPTION OF THE FIGURES

Other advantages, aims and features of the present invention will emerge from the following description, given for explanatory and nonlimiting purposes in light of the attached drawings, in which:

FIG. 1 represents a drone in a particular embodiment of the invention,

FIGS. 2A and 2B represent the flight and air braking positions of the rear tail unit,

FIG. 3 illustrates the arrangement of the rear tail unit locking device,

FIG. 4 schematically illustrates the inflatable pneumatic landing gear, in folded back position (top Figure) and in deployed position (bottom Figure),

FIG. 5 very schematically illustrates the principle of a breakable attachment device between a wing and the fuselage of the aircraft, in profile view,

FIG. 6 is a similar illustration, in plan view, with the wing removed,

FIG. 7 illustrates, by bottom view, a wing/fuselage attachment device in a hard landing case (the fuselage and the pins are masked),

FIG. 8 illustrates the same device, according to an AA cross-sectional view (some internal elements of the wing and of the fuselage are masked for legibility reasons),

FIG. 9 again illustrates the same device, according to a plan view (the wing is represented transparently, some internal elements of the wing are masked for legibility reasons),

FIG. 10 illustrates the principle of a fuselage that can be broken at the rear tail unit, when the two parts of the fuselage are assembled,

FIG. 11 illustrates the same device, when the fuselage is separated into two parts,

FIG. 12 similarly illustrates the instant of the dislocation following the release of the “fail-safe” hook,

FIG. 13 illustrates the jettisonable tail and the housing (shown here by an oval hole) of a parachute,

FIG. 14 illustrates, in a way complementary to FIG. 13, the rear face of the front part of the fuselage, on which can be seen, at the top, the “fail-safe” hook, and, at the bottom, in the form of two lateral rectangles, the snap-fit attachment device,

FIG. 15 illustrates the details of the “fail-safe” hook in locking position Figure on the left) and release position (Figure on the right), and

FIG. 16 illustrates an exemplary embodiment of the landing gear made of foam with shape memory (17).

### DETAILED DESCRIPTION OF EXEMPLARY EMBODIMENT OF THE INVENTION

Note now that the Figures are not to scale.

The invention relates to the context of an aircraft of drone type, remotely controlled or auto-piloted.

A geometrical reference frame is defined comprising a longitudinal axis X determined as the direction of flight of the aircraft, and oriented in the direction of normal movement of the aircraft. Similarly, there are defined a vertical plane XZ by the longitudinal axis and the axis of aerodynamic thrust of the aircraft, a vertical axis Z defined as at right angles to the longitudinal axis X and situated in this vertical plane XZ, oriented in the direction of the aerodynamic thrust in normal flight of the aircraft. Finally, a transverse axis is defined, defined as at right angles to the other two axes. This transverse axis Y is situated overall in the plane of the main wing of the aircraft.

Notions of front, rear, top, bottom, etc., are defined in relation to this reference frame.

Rear of the aircraft should be understood for example to mean the part opposite the direction of flight of the aircraft.

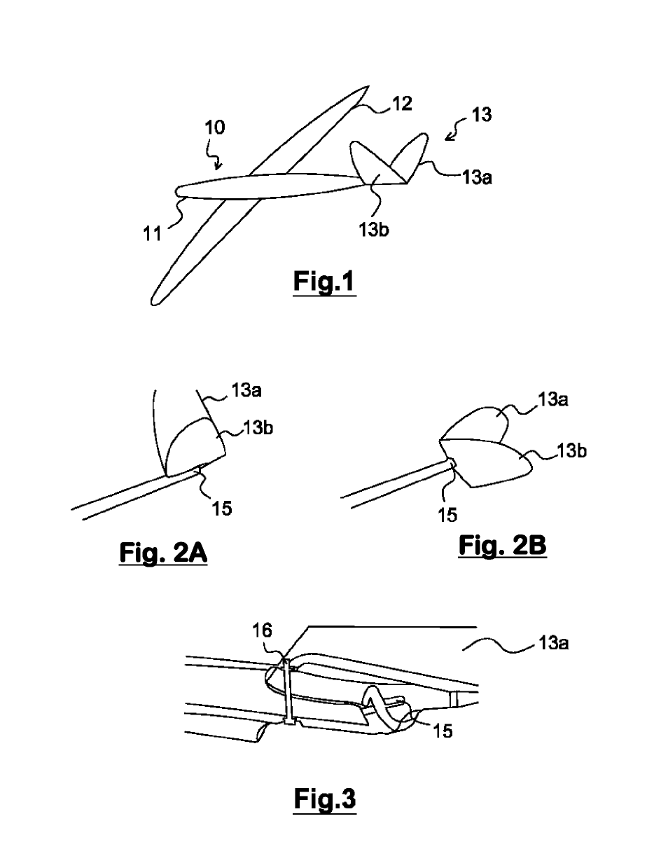

In the present exemplary embodiment, as illustrated by FIG. 1, said aircraft 10 comprises a fuselage 11, a main wing 12, and a tail unit 13, here arranged in the rear part of the fuselage 11.

In this exemplary embodiment, the aircraft (10) comprises a landing gear made of foam with shape memory (17) under its fuselage, as illustrated by FIG. 16, which is a replaceable wear part protecting the fuselage from impacts upon hard landings.

This landing gear made of foam with shape memory (17) can consist of one or more flexible materials, for example polypropylene, polyurethane, polystyrene, plastic, elastomers, composite materials, rubber, or any other material exhibiting the requisite mechanical qualities.

The thickness of this landing gear made of foam with shape memory (17) can be easily calculated by a person skilled in the art according to the weight of the aircraft (10), the planned impact speed on landing, and the resistance to impacts of the structures and payloads of the aircraft.

The shape of the landing gear made of foam with shape memory (17) can vary according to the embodiment of the invention. It can for example be distributed over all or part of the bottom face of the fuselage of the aircraft (10), or over the bottom face of a part of its wings or tail units or both, in one or more blocks. The landing gear made of foam with shape memory can cover the nose of the aircraft (10) to protect it in some embodiments. The landing gear made of foam with shape memory can have openings to clear the way for cameras or other sensors. It can have a shape facilitating the take-off of the aircraft (10), for example a handle for launching by hand, a cavity allowing it to be driven on a ramp, or other shapes. The landing gear made of foam with shape memory can be partially hollowed out to make it more deformable.

This landing gear made of foam with shape memory (17) offers numerous advantages. It dampens the impacts on landing, and protects the aircraft (10) from scratches or perforations. It can be made of a material that is lightweight, inexpensive, and very easy to machine. Said landing gear made of foam with shape memory (17) can therefore be replaced easily and at lower cost after wear or breakage.

The tail unit 13 is, here, made up of two oblique parts, producing a so-called “butterfly” or “V” tail unit, that is known per se. This tail unit consists of two inclined surfaces 13a, 13b, ensuring both the equilibrium and the control of the aircraft.

The two inclined surfaces 13a, 13b are linked at the level of a link line, the surfaces 13a, 13b forming an angle between them, for example of around 90°. The tail unit 13 is secured to the fuselage of the aircraft, in the rear part thereof, on the one hand, by a central pivot 15 placed at right angles to the longitudinal axis X, in the plane of the fixed wing and, on the other hand, by a device for locking 16 the tail unit 13 in flight position (see FIG. 3).

The tail unit 13 has a first position (FIG. 2A), called flight position, in normal flight in which airfoils 13a, 13b are positioned globally along the longitudinal axis X of the flight trajectory of the aircraft 10. In this first position, the locking device 16 is active and holds the tail unit in a position such that the two airfoils are globally parallel to the air flow, that is to say to the direction of movement of the aircraft.

The tail unit 13 also has a second position (FIG. 2B), implemented for example upon a loss of control of the aircraft, in which the locking device 16 is released.

When it is released from its position in the axis of flight, the tail unit 13 naturally comes, under the effect of the aerodynamic forces, to be placed in a maximum air braking position. The tail unit 13 then performs a rotation of substantially 90 degrees toward the rear of the aircraft, thus placing its airfoils 13a, 13b in their position of maximum aerodynamic drag, the link line between the tail units 13a, 13b coming to be placed substantially at right angles to the longitudinal axis X.

The tail unit 13 then has a high resistance to the air and slows down the horizontal flight speed and reduces the dropping speed of the aircraft 10. In this way, the kinetic energy of the aircraft is reduced compared to a dropping of an aircraft not provided with this device. In this way, a controlled dropping rate can be ensured (for example with a maximum value of −8 m/s), even in case of loss of the critical piloting system.

In the present embodiment, given here as a nonlimiting example, the aircraft 10 is piloted by a microcontroller linked to an electronic circuit (not illustrated in the Figures) and the tail unit 13 is held in its first position by the locking means 16 linked to the electronic circuit of said aircraft 10.

The triggering of the transition between the first position, that is to say the “normal” flight position, and the second position, that is to say the air braking position of the tail unit, is, in the present exemplary embodiment, provoked by the powering up of a resistive wire which then breaks when it is heated up. When it breaks, it releases the locking device 16 which holds the tail unit 13 in flight position.

In the present exemplary implementation, the device triggering the transition between the two flight positions of the tail unit 13 has its own power supply, notably to be used even in case of electrical failure of the aircraft.

Regarding the triggering logic, the triggering takes place when one of the following conditions is reached:
absence of voltage measured on the bus of the “servos” (that is to say the control mechanisms of the aerodynamic surfaces of the craft) or the onboard electronics bus,
absence of “life sign” on the part of the onboard electronics (the “life sign” being an electrical signal which makes it possible to detect that the onboard electronics are functioning).

In this way, a “fail-safe” device is effectively created, in which, in case of loss of control of the drone, the latter is set automatically to recovery configuration, here by air braking.

In a variant, the aircraft 10 here uses, as locking device 16, an electromagnet. In this way, in the absence of electrical power supply of the piloting control system, the electromagnet no longer holds the tail unit in place and the latter performs a rotation of 90 degrees toward the rear of the aircraft under the effect of the thrust of the air.

In another variant, once switched from the flight position to the air braking position, the tail unit 13 is held by a second mechanical locking means (not illustrated in the Figures) in air braking position, for example by a non-return ratchet. Thus, once the tail unit 13 is brought into the air braking position, the ratchet prevents said tail unit from returning to flight position.

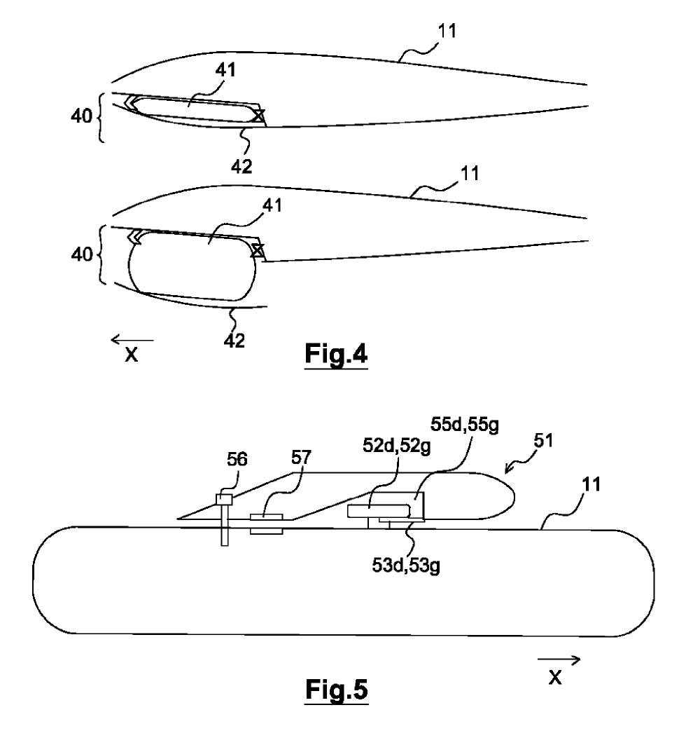

In another embodiment, possibly but not mandatorily used in conjunction with the preceding one, the aircraft 10 comprises an inflatable pneumatic landing gear 40, that can be deployed under its fuselage 11 (see FIG. 4).

In this exemplary embodiment, the inflatable pneumatic landing gear 40 has a flight position (FIG. 4, top) in which it is deflated and is retracted into the fuselage 11 of the aircraft. The pneumatic landing gear 40 has a landing position (FIG. 4, bottom), in which it is inflated with a gas and deployed out of the fuselage 11 of the aircraft 10.

The inflatable pneumatic landing gear 40 comprises, in the present example, a closed chamber 41 of the type with shape memory. This closed chamber 41 can be made of any flexible material, allowing the inflatable pneumatic landing gear 40 to switch from a deflated form suitable for being retracted into the fuselage 11, to an inflated form, capable of damping the contact of the aircraft with the ground upon landing.

In one implementation, the closed chamber 41 is held under vacuum air pressure as long as it is in the folded back (deflated) position. The control of the opening of a valve (not visible in the Figures) makes it possible for the outside air to enter into the closed chamber 41, and causes the spontaneous re-inflation of said chamber by the entry of the outside air, and the subsequent deployment of the inflatable pneumatic landing gear 40. This runs counter to the existing inflatable landing cushion devices, for which the latter are inflated either by opening a compressed air cartridge, or by the action of a pyrotechnical cartridge which serves as gas generator, or by any other device whose function is to inflate the gear by the application of a pressure greater than atmospheric pressure.

The control of the opening of the valve is carried out by the electronic control circuit of the aircraft, or by remote control.

The re-inflation of the closed chamber 41 and the deployment of the inflatable pneumatic landing gear 40 can be done on approaching the ground. It is then for example triggered by a program run on a microcontroller, linked for example to an altimeter.

Similarly, the inflatable pneumatic landing device is also “fail-safe”, in case of loss of control of the drone, the closing valve of the closed chamber 41 is automatically released, and the inflatable pneumatic landing gear 40 is therefore deployed.

The inflatable pneumatic landing gear device 40 is here retractable by hand by virtue of a valve allowing the air to circulate from the inside to the outside of the closed chamber 41.

The part intended to enter into contact with the ground of the inflatable landing gear comprises, in the present example, a cover 42 which, in flight position, forms an aerodynamic continuity with the rest of the fuselage 11. This cover 42 here, but not mandatorily, consists of the same material as the rest of the fuselage, and, upon the deployment of the inflatable pneumatic landing gear 40, this cover 42 forms a wear skid intended to protect the closed chamber 11 from any damage upon contact with the ground.

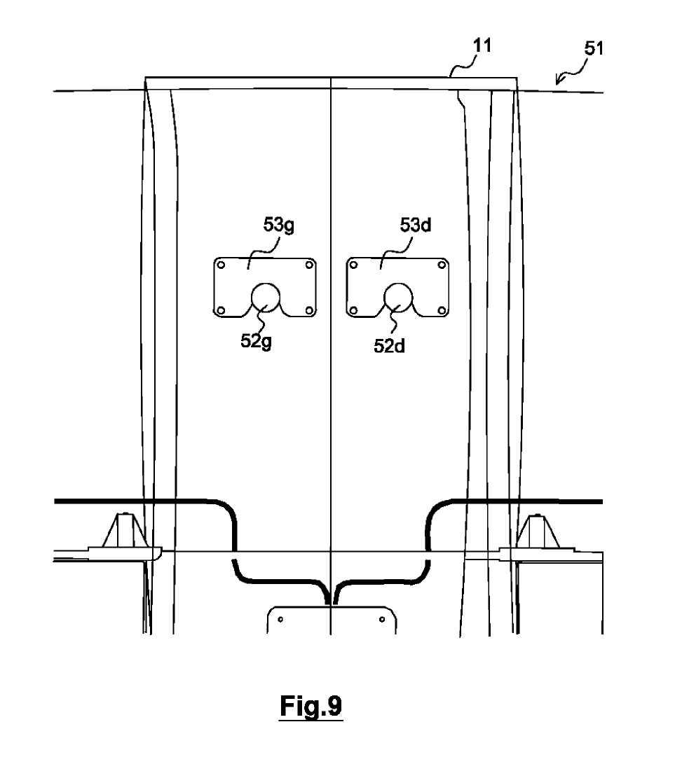

In a variant embodiment (see FIGS. 5 to 9), intended to allow the separation of the wing relative to the fuselage 11 upon a hard landing, by avoiding the breaking of one or the other as much as possible, the aircraft is provided with a device for attaching the wings to the fuselage 11 comprising a mechanical element serving as “fuse” in case of a load greater than a previously determined value. In this exemplary embodiment, the main wing 51 is formed of a single piece and is attached above the fuselage 11 in normal flight of the aircraft.

The device for attaching the wing 51 to the fuselage 11 consists, at the fuselage 11 level, of two fixing pins 52d, 52g placed on either side (slightly forward) of the center of gravity of the airplane.

These fixing pins 52d, 52g each slide under a metal plate 53d, 53g respectively, comprising a notch 54d, 54g cut in a V, these metal plates 53d, 53g being fixed to the wing 51, under grooves 55d, 55g formed in the volume of the wing 51.

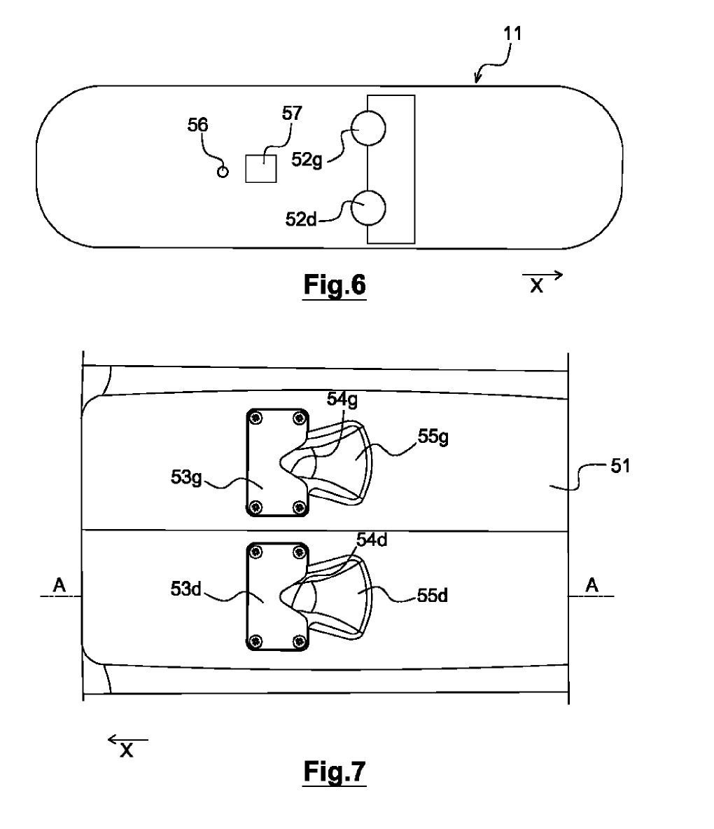

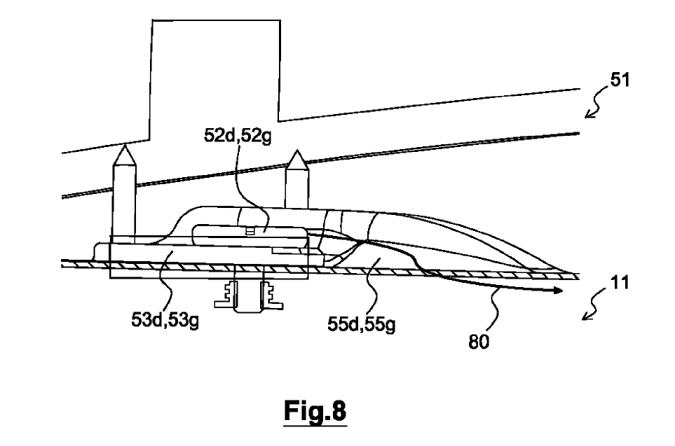

In FIGS. 5 and 6, the front of the airplane is on the right of the Figure (whereas it is on the left in FIGS. 7 and 8). FIG. 5 shows the wing 51 placed above the fuselage 11. In this FIG. 5, the fixing pins 52d, 52g are each inserted into a corresponding notch 54d, 54g of the metal plates 53d, 53g.

The grooves 55d, 55g formed locally in the bottom face of the wing 51 make it possible to accommodate the volume of the fixing pins 52d, 52g.

In the present nonlimiting exemplary embodiment, the wing 51 is held in place on the fuselage 11 by a screw 56 which is placed at the back of the wing 51 and which keeps a fuselage/wing electrical connector 57 gripped. The function of this fuselage/wing electrical connector is to allow the passage of the power supply current for the various systems incorporated in the wing 51. The screw 56 is dimensioned so as to break by shearing when the forward acceleration undergone by the airplane is greater than a predetermined value.

When the fuselage 11 is stopped short, typically upon a hard landing, the screw 56 is broken by shearing and the wing 51 is separated from the fuselage 11 toward the front. In this case, the trajectory of the fixing pins 52d, 53g in the grooves 55d, 55g under the wing 51 is illustrated by the curve 80 in FIG. 8.

When one side of the wing 51 touches the ground first, the screw 57 is broken by shearing from the side and the wing 51 is separated from the fuselage 11 asymmetrically.

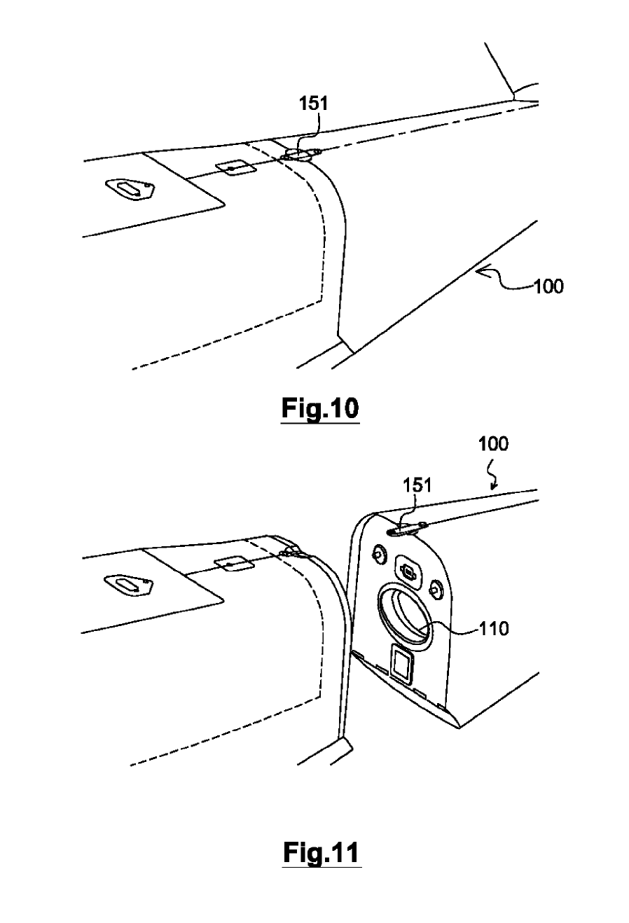

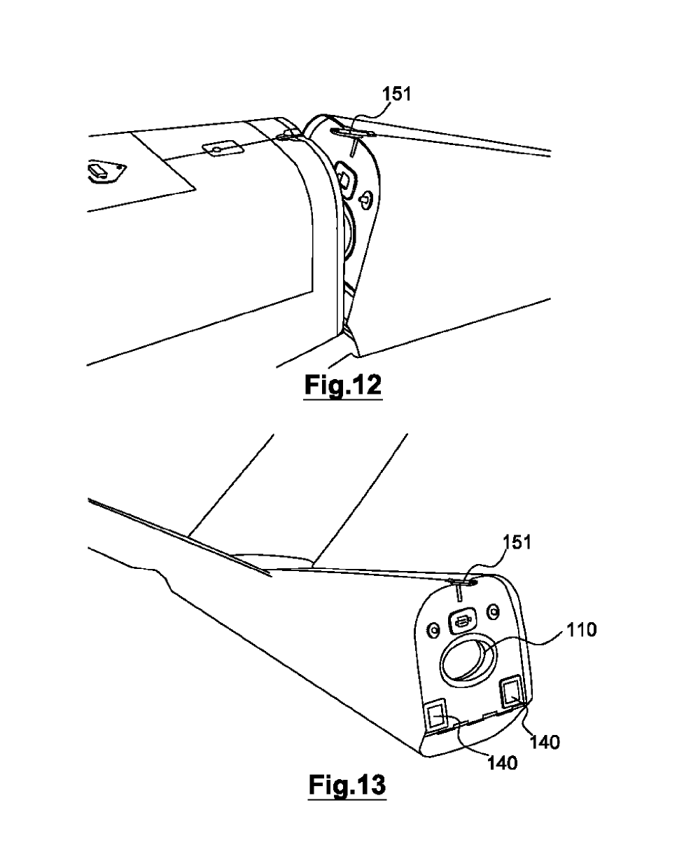

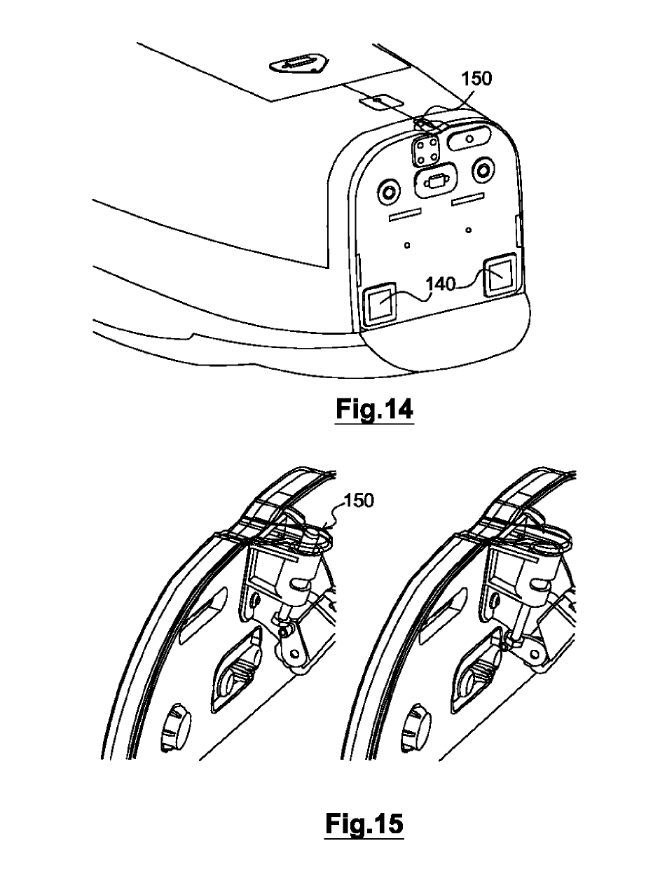

In a variant embodiment illustrated by FIGS. 10 to 15, the aircraft is equipped with a jettisonable tail 100 comprising a housing 110 for a parachute. When this tail is jettisoned, the parachute is deployed and ensures a return to the ground without breaking (“safe”).

The attachment device between the fuselage and the tail is made up of the following elements:

A hook 150 of fail-safe type that can be controlled by the autopilot, which is taken up in an attachment 151 above the tail of the aircraft, and thus moors the top of the tail 100 to the top of the fuselage.

A snap-fit device 140 for attaching the bottom of the tail with the bottom of the fuselage.

Functions:

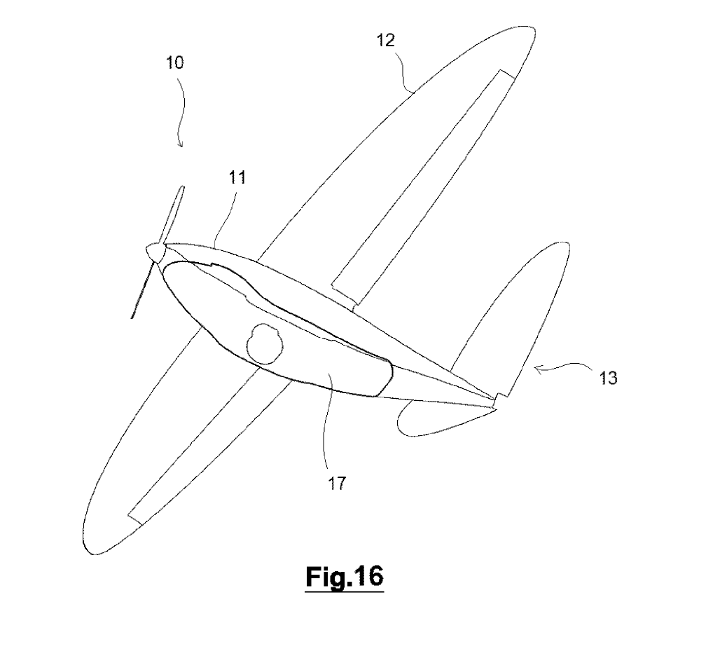

When the fail-safe hook 150 is deactivated (FIG. 15, on the right), the tail is dislocated and releases the parachute.

Upon an impact (for example, an abrupt landing), the “snap-fit attachment device” is dislocated, avoiding physical breakage.

1-12. (canceled)

13. A fixed-wing aircraft, comprising at least one passive landing assistance unit deployable between a first position used in a normal flight and a second position; a trigger to active a transition from the first position to the second position; and a landing gear made of foam with a shape memory.

14. The fixed-wing aircraft as claimed in claim 13, wherein the trigger is activated automatically in a loss of control of the fixed-wing aircraft.

15. The fixed-wing aircraft as claimed in claim 13, wherein the passive landing assistance unit is used in case of an emergency.

16. The fixed-wing aircraft as claimed in claim 13, further comprising a fuselage and a tail unit at a rear of the fuselage, the tail unit comprising at least two airfoils; and wherein the tail unit having, relative to the fuselage, a flight position in which said at least two airfoils are positioned substantially in a longitudinal axis X of a flight trajectory of the fixed-wing aircraft and an air braking position in which said at least two airfoils form an angle greater than 60° with the longitudinal axis X of the flight trajectory to form an air brake by the tail unit.

17. The fixed-wing aircraft as claimed in claim 16, further comprising a main wing and a lock to lock the tail unit in the flight position; and wherein the tail unit is of a V type tail unit consisting of two airfoils, the tail unit is secured to the fuselage by a pivot placed at right angles to the longitudinal axis X, in a plane of the main wing, the pivot is arranged substantially at a mid-length under the tail unit.

18. The fixed-wing aircraft as claimed in claim 17, further comprising a flight controller to pilot the fixed-wing aircraft and to control the lock to lock the tail unit in the flight position.

19. The fixed-wing aircraft as claimed in claim 17, wherein the lock comprises a breakable resistive wire and a heater to heat the breakable resistive wire.

20. The fixed-wing aircraft as claimed in claim 13, further comprising an inflatable pneumatic landing gear.

21. The fixed-wing aircraft as claimed in claim 20, wherein the inflatable pneumatic landing gear comprises a closed chamber with a shape memory, the inflatable pneumatic landing gear having a flight position in which the closed chamber is kept folded back by a vacuum pressure within the closed chamber and retracted into the fuselage of the fixed-wing aircraft, and a landing position in which the closed chamber is deployed by opening a valve of the closed chamber to outside air to inflate to an ambient pressure and out of the fuselage of the fixed-wing aircraft.

22. The aircraft as claimed in claim 13, further comprising a wing-fuselage link that can be dislocated by a main attachment configured to absorb forces during the normal flight; and a fuse configured to break in response to abnormal loads encountered during a hard landing.

23. The aircraft as claimed in claim 13, further comprising a fuselage-tail link that can be dislocated in response to an impact or release of a fail-safe hook.

24. The aircraft as claimed in claim 23, further comprising a dislocatable tail and a parachute housed in the dislocatable tail, the parachute is released upon a dislocation of the dislocatable tail.
